(19) United States
(12) Patent Application Publication
(10) Pub. No.: US 2006/0051527 A1
(43) Pub. Date: Mar. 9, 2006

(54) Thermal transfer image receiving sheet and image forming method

(76) Inventor: Satoshi Okano, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/212,257

(22) Filed: Aug. 26, 2005

(30) Foreign Application Priority Data
Sep. 8, 2004 (JP) JP2004-260649

(51) Int. Cl. B41M 5/40

(52) U.S. Cl. 428/32.5

(57) ABSTRACT

A thermal transfer image receiving sheet including: a substrate sheet; and a pigment receiving layer which is capable of receiving a thermal diffusible pigment and includes inorganic particles and hydrophobic resin, wherein a void ratio of said pigment receiving layer is 10 through 60%.

This application is based on Japanese Patent Application No. 2004-260649 filed Sep. 8, 2004, in Japanese Patent Office, the entire content of which is hereby incorporated by reference.

### TECHNICAL FIELD

The present invention relates to a thermal transfer image receiving sheet and image formation method using the same.

### BACKGROUND

The techniques for color monochrome image formation known in the prior art include the so-called dye thermal transfer method. According to this method, an ink sheet containing a thermal diffusible pigment having a property of diffusion and migration upon heating is arranged opposite to the receiving layer of an image receiving sheet (also known as a pigment receiving layer). Then the thermal diffusible pigment is transferred onto this receiving layer in the form similar to an image, using such a thermal printing means as a thermal head and lasers whereby an image is formed. Such a thermal transfer method is forms an image using digital data, and produces a high-quality image comparable to a silver halide photograph, without using such a processing solution as a developing solution. For these advantages, the thermal transfer method is highly evaluated.

The image formation method using the aforementioned pigment thermal transfer method requires a technique for improving the print speed (high speed printing technique) in order to reduce the print-out time per one sheet. To meet this requirement, various efforts have been made to study the thermal transfer ink sheet as well as thermal transfer image receiving sheet. However, no effort has succeeded in reaching the characteristics meeting this requirement.

To get the sufficient printing density in the high speed printing, it may be possible to use a thermal transfer method wherein the mount of the pigment of the thermal transfer ink sheet is increased with respect to the binder resin for holding it, or much energy is used. However, increase in the amount of pigment and use of much energy has raised a problem of increased density (fog) on the low-density portion and non-image portion. Further, a fog tends to occur in the printing environment characterized by high temperature and humidity in the Southeast Asia. For example, a fog tends to occur in the method of adding the compound of the thermal transfer image receiving sheet (disclosed in the Patent Document 1) to the receiving layer, wherein this thermal transfer image receiving sheet contains a plasticizer composed of at least one compound and/or condensed substance selected from among the styrene based homopolymer, inorganic ester compound a molecular weight of 250 through 1000 and organic ester based compounds.

One of the arts of improving the anti-fogging performance disclosed so far includes a thermal transfer ink sheet which can be used a number of times, wherein a hot melt type multiple transfer ink layer is arranged on the substrate, and a hot melt overcoating layer having greater cohesion than this hot melt type multiple transfer ink layer is arranged thereon (e.g., Patent Document 2). Another art having been disclosed is the thermal transfer ink sheet containing the ink layer with a hydrophobic cationic dye on the sheet-like substrate. In this sheet, the ink layer contains the adsorption holding agent of the hydrophobic cationic dye (e.g., Patent Document 3). These methods provide technical improvements using a thermal transfer ink sheet. In the meantime, in the art of forming a void layer using inorganic particles, the recording material for sublimation thermal transfer is disclosed (for example, in Patent Document 4), wherein the receiving layer for dyeing a sublimable dye is impregnated with a resin and a pigment of inorganic particles with silica and alumina contained in each particle.

However, the art described in Patent Document 4, for example, is intended to achieve a high image density and to improve anti-sticking performances. It fails to discuss fog problems such as an increase in density on the low-density portion and faulty transfer on the non-image portion. Further, the void ratio of the void layer is not mentioned.

[Patent Document 1] Official Gazette of Japanese Patent Tokkai 2000-218947

[Patent Document 2] Official Gazette of Japanese Patent Tokkaihei 5-185755

[Patent Document 3] Official Gazette of Japanese Patent Tokkaihei 8-72420

[Patent Document 4] Official Gazette of Japanese Patent Tokkai 2001-334754

In view of the prior art described above, it is an object of the present invention to provide a thermal transfer image receiving sheet characterized by excellent anti-fogging performances and a high degree of image density (printing density), and an image formation method using the same.

### SUMMARY

One aspect of the present invention is characterized by the following structure:

A thermal transfer image receiving sheet including: a substrate sheet; and a pigment receiving layer which is capable of receiving a thermal diffusible pigment and includes inorganic particles and hydrophobic resin, wherein a void ratio of said pigment receiving layer is 10 through 60%.

Another aspect of the present invention is characterized by the following structure:

An image forming method including the steps of: superimposing said thermal transfer image receiving sheet of claim 1 on a thermal transfer ink sheet containing thermal diffusible pigments; heating said thermal transfer image receiving sheet and thermal transfer ink sheet superimposed thereon according to recording signals; and transferring the thermal diffusible pigment contained in the thermal transfer ink sheet onto the thermal transfer image receiving sheet.

### BRIEF DESCRIPTION OF THE DRAWINGS

FIG. 1 is a cross sectional view representing the structure of a thermal transfer image receiving sheet of the present invention;

FIG. 2 is a perspective view representing an example of a thermal transfer ink sheet of the present invention; and

FIG. 3 is a schematic diagram representing the structure of a thermal transfer recording apparatus.

### DESCRIPTION OF THE PREFERRED EMBODIMENT

The present invention provides a thermal transfer image receiving sheet characterized by excellent anti-fogging performances and a high degree of image density (printing density), and an image formation method using the same.

The following provides a detailed description of the best form in the embodiment of the present invention:

In an effort to solve the aforementioned problems, the present inventors have found out that excellent anti-fogging performances and a high degree of image density (printing density) can be achieved by a thermal transfer image receiving sheet having a pigment receiving layer capable of receiving thermal diffusible pigments on a substrate sheet, wherein the pigment receiving layer includes inorganic particles and hydrophobic resin, and has a void ratio 10 through 60%. This finding has lead to the present invention.

The pigment receiving layer (hereinafter referred to as “receiving layer” for short) constitutes a void layer composed of a void structure using inorganic particles and hydrophobic resin (hereinafter referred to as “hydrophobic resin binder”)., wherein the void ratio of this void layer is kept within a predetermined range.

The following will first describes the inorganic particles constituting the receiving layer of the present invention:

Hydrophobic silica, alumina/silica oxide mixture with silica and alumina contained in one particle, and alumina doped silica with alumina doped onto the silica particle surface are preferably used as the inorganic particles to be used with the receiving layer of the present invention. This is because these substances have an affinity with the hydrophobic resin and are effective in achieving the object of the present invention.

The hydrophobic silica having been subjected to surface treatment with hexamethyl disilazane can be mentioned as an example of the hydrophobic silica. The hydrophobic silica having been subjected to surface treatment with hexamethyl disilazane is available on the market under the name of hydrophobic silica anhydride H-2000, H-2000/4 and H-3004 by Wacker Chemicals East Japan Inc., for example.

Alumina doped silica can be manufactured by adding silica particles to the solution including the aluminum compound and by coating the surface thereof with the solution (solution method); by gasifying an aluminum and silicon compound and allowing the gas mixture to be reacted in flames (flame hydrolysis method); or by a combination of the pyrolysis method and flame hydrolysis method. The alumina doped silica is preferably doped with alumina within the range of 1×10⁻⁵ through 20 percent by mass.

Use of other inorganic particles is also preferred. For example, titanium dioxide or aluminum oxide provided with hydrophobing is preferred. To put it more specifically, the substance provided with surface treatment by hexamethyl disilazane can be mentioned. It is also possible to use-the inorganic particles of synthetic amorphous silica, colloidal silica, light calcium carbonate, heavy calcium carbonate, magnesium carbonate, kaolin, clay, talc, calcium sulfide, barium sulfide, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, pseudoboehmite, aluminum hydroxide, lithopone, zeolite and magnesium hydroxide.

These inorganic particles can be used as either primary particles or secondary flocks. The average particle size of these inorganic particles (primary particle size if used as primary particles, or secondary flock size or secondary flocks) is preferably; 1 through 300 nm for the primary particle, more preferably 3 through 100 nm, and still more preferably 5 through 80 nm. The average particle size of the secondary flock is preferably 1 through 150 nm. The average particle size of the inorganic particle is preferably kept within the aforementioned range in order to maintain a high degree of adhesion with the thermal transfer ink sheet or a high image density. The amount of inorganic particles to be added depends on the required void rate of the void layer. Generally, it is approximately 1 through 50 grams per square meter of the thermal transfer image receiving sheet, preferably 1 through 25 grams. The ratio between inorganic particles and hydrophobic resin is approximately 0.5 to 1 through 7 to 1.

The following describes a hydrophobic resin as another component constituting the receiving layer of the present invention:

The present invention allows use of the hydrophobic resins known in the prior art. Among the hydrophobic resins known in the prior art, those that can be easily dyed by a pigment are preferably used. To put it more specifically, it is possible to mention a vinyl based resin such as polyvinyl chloride, polyvinyl acetate, polyacrylic acid ester and their copolymer; a polyester resin such as polyethylene terephthalate and polybutylene terephthalate; a copolymer with other vinyl based monomer such as polyamide resin, phenoxy resin, ethylene and propylene; and an independent or mixed polymer of an organic solvent such as polycarbonate, acryl resin, ionomer resin and cellulose derivatives. Of these substances, polyester resin, vinyl resin, the copolymer thereof and cellulose derivative are preferably used.

The following describes the void ratio in the present invention.

In the present invention, the void rate of the pigment receiving layer is 10 through 60%. The object of the present invention can be achieved within the aforementioned range. The void rate in the sense in which it is used here refers to the value defined by the following equation:

Void rate (%)=[(dry film thickness of the pigment receiving layer−film thickness of solid content in pigment receiving layer coating solution)/dry film thickness of the pigment receiving layer]×100

The term “film thickness of solid content in pigment receiving layer coating solution” here is a thickness of film consisted of the solid content in pigment receiving layer coating solution when an amount of coating (g) per unit area (m2) is constant.

Furthermore the term of “dry film thickness of the pigment receiving layer” here can be changed according to the drying condition to adjust the void ratio based on the above equation.

For example when the pigment receiving layer is completely dried as the drying condition the void ratio approach 0% since the film thickness comes close to the film thickness of solid content.

In the method of increasing the printing speed wherein organic phosphine compound, phosphoric acid ester compound; phthalic acid ester compound, aliphatic dibasic acid ester compound or trimellitic acid ester compound of the present invention (hereinafter referred to collectively as “Group A compound”) is added to the receiving layer of the thermal transfer image receiving sheet, for example, the receiving layer is arranged to have the structure to be defined in the present invention. This arrangement allows the object of the present invention to be achieved more effectively. It also improves anti-blocking performances. Blocking in the present invention can be defined as a problem wherein the sheet conveyance performance is reduced and the rear layer function is deteriorated because the receiving layer surface and substrate sheet rear layer are bonded with each other when the thermal transfer image receiving sheet is rolled.

In the present invention, Group A compound (organic phosphine compound, phosphoric acid ester, phthalic acid ester compound, aliphatic dibasic acid ester compound or trimellitic acid ester compound) is characterized by a high degree of miscibility with resin and plasticization effect.

Specific examples of the organic phosphine compound include tri-n-octylphosphine, tricyclohexylphosphine, triphenylphosphine, tri-n-octylphosphine oxide, and triphenylphosphine oxide. Specific examples of the phosphoric acid ester include trimethyl phosphate, tributyl phosphate, triethyl phosphate, tri(2-ethylhexyl)phosphate, triphenyl phosphate, tricresyl phosphate, trixylenyl phosphate, tricresylphenyl phosphate, and 2-ethylhexylphenyl phosphate. Further, phosphoric acid ester includes an aromatic condensed phosphoric acid ester compound. It is sold on the market under the tradename of CR-733S (Daihachi Kagaku Kogyo Co., Ltd.), CR-741 (Daihachi Kagaku Kogyo Co., Ltd.) and CR-747 (Daihachi Kagaku Kogyo Co., Ltd.). Specific examples of the phthalic acid ester compound include dimethyl phthalate, diethyl phthalate, dibutyl phthalate, dioctyl phthalate (=2-ethylhexyl phthalate), dicyclohexyl phthalate and diphenyl phthalate. The aliphatic dibasic acid ester compound is preferably a sebacic acid ester compound or adipic acid ester compound. The specific examples of the adipic acid ester compound include diisooctyl adipate, diisodesyl adipate, dioctyl adipate, didesyl adipate and desylisooctyl adipate. The specific examples of the trimellitic acid ester compound include tris (2-ethylhexyl) trimellitate, trinormal octyl trimellitate, triisodesyl trimellitate and trinormal octyl trimellitate. The aforementioned specific examples are not restricted to those given above.

The content of the aforementioned Group A compound is preferably within the range from 0.5 through 70 percent by mass with respect to hydrophobic resin. The amount to be added is preferably 0.5 through 15 grams per square meter.

A more effective means for achieving the object is provided by formation of the pigment receiving layer of the thermal transfer image receiving sheet including a metal ion-containing compound (hereinafter referred to as “metal source”) in the post-chelate type sublimable image formation using the post-chelate type thermal diffusible pigment capable of chelating with metal. In this sense, this arrangement is preferable in the present invention.

An inorganic or organic metallic complex of metal ion can be mentioned as the aforementioned metal source. Either of them is used preferably. Of these, the organic metallic complex is more preferred. The metal is exemplified by monovalent and polyvalent metals pertaining to Groups I through VIII of the periodic table. Of these metals, Al, Co, Cr, Cu, Fe, Mg, Mn, Mo, Ni, Sn and Zn are preferably used. Ni, Cu, Cr, Co and Zn are preferably used in particular.

Specific examples of the metal source include inorganic substances with Ni²⁺, Cu²⁺, Cr²⁺, Co²⁺ and Zn²⁺, fatty acid salts such as acetic acid and stearic acid, or aromatic carbonic acid salts such as a benzoic acid and salicylic acid.

In the present invention, the complex defined by the following general formula (A) can be added stably in the receiving layer, and is virtually colorless, so that this complex is preferably utilized in particular.

General Formula (A)
[M (Q₁)_{X}(Q₂)_{Y}(Q₃)_{Z}]^{P+}(L⁻)_{P}

In the general formula (A), M denotes a metal ion, preferably Ni²⁺, C²⁺, Cr²⁺, Co²⁺ and Zn²⁺, Q₁, Q₂ and Q₃ indicate coordinate compounds capable of coordinate linkage with the metal ions expressed by M. They can be the same with each other or different from each other. These coordinate compounds can be selected from coordinate compounds described in Chelate Chemical (5) (Nankodo Inc.), for example. L denotes the organic anion group. To put it more specifically, this group includes a tetraphenyl boric acid anion and an alkylbenzene sulfonic acid anion. X denotes an integer of 1, 2 or 3. Y represents 1, 2 or 0. Z indicates 1 or 0. These symbols depend on whether the complex defined by the aforementioned general formula is a quadridentate or sexadentate coordinated complex, or on the number of ligands Q₁, Q₂ and Q₃. P denotes 1 or 2. Specific examples of the meal source of this kind include the ones described in the Specification of the U.S. Pat. No. 4,987,049, and the compounds 1 through 51 given in the Official Gazette of Japanese Patent Tokkaihei 10-67181.

The amount of metal source to be added is preferably 5 through 80% by mass with respect to the binder of the pigment receiving layer, and more preferably 10 through 70% by mass. The amount of metal source to be added is preferably 0.5 through 20 grams per square meter normally, and more preferably 1 through.15 grams per square meter.

The thermal transfer image receiving sheet can be provided with other layers in addition to the pigment receiving layer, as required. More than two pigment receiving layers can be provided. In this case, the structures of these pigment receiving layers can be the same or different from each other. For example, it is possible to mention a two-layer structure wherein a layer composed of the aforementioned hydrophobic resin is formed, without any void layer above the pigment receiving layer, and a two-layer structure wherein a layer composed of the aforementioned hydrophobic resin is formed, without any void layer below the pigment receiving layer. Further, in the two-layer structure, it is possible to use the hydrophobic resin constituting the pigment receiving layer and the hydrophobic resin constituting the upper or lower layer wherein their glass-transition temperatures (Tg) are different from each other.

The pigment receiving layer of the present invention and other layers can be coated according to the method selected from the coating methods known in the prior art. One of the preferred methods is to coat the support member with the coating solutions constituting each layer and to dry it. In this case, simultaneous coating of two or more layers is also possible. Specific coating methods include the gravure coat method (gravure coating method), gravure reverse coating method, bar coating method, spray coating method and roll coating method. The coating film of the pigment receiving layer is normally 1 through 50 μm although there is no special restriction thereto.

The following describes the components of the thermal transfer image receiving sheets other than the aforementioned ones:

s(Mold Releasing Agent and Fine Particle)

A mold releasing agent is preferably applied to the pigment receiving layer of the present invention in order to avoid thermal fusion with the ink layer of the thermal transfer ink sheet. To put it more specifically, the mold releasing agent includes paraffin, fluorinated paraffin, fluorine compound and silicone oil (including the reactive curing type silicone). Of these agents, silicone oil is preferred as a mold releasing agent. Dimethyl silicone and other various types of modified silicone can be used as silicone oil. To put it more specifically, such silicone oil includes amino-modified silicone, epoxy-modified silicone, alcohol-modified silicone, vinyl-modified silicone and urethane-modified silicone. They are blended or polymerized various forms of reaction for use. One or more than two mold releasing agents can be used. The amount of the mold releasing agent to be added is preferably 0.5 through 30 parts by mass, with respect to 100 parts by mass of binder resin for pigment receiving layer formation, in order to avoid fusion between the thermal transfer ink sheet and thermal transfer image receiving sheet, and to prevent printing sensitivity from being reduced. Without being added to the pigment receiving layer, these mold releasing agents can be arranged as a separate mold releasing layer on the pigment receiving layer. Further, the receiving layer may contain fine particles composed of organic high molecular material.

The organic high molecular materials are fine particles compatible with the hydrophobic resin binder. The specific compounds thereof include polystyrene, polyacryl amides, polyethylene, polypropylene, copolymer composed of the monomers constituting them, polyimide resin, urea resin or melamine resin, cellulose resin, styrene resin, nylon, phenol resin and silicone resin. Further, the average particle size of these fine particles is preferably about 0.1 through 40 μm in order to ensure uniform images to be formed.

(Substrate Sheet)

The substrate sheet used in the thermal transfer image receiving sheet has a function of maintaining the pigment receiving layer, as well as the mechanical strength sufficient to permit easy handling even when overheated, since heat is applied during heat transfer.

Without being restricted to any particular type, the aforementioned substrate material that can be utilized includes capacitor paper, glassine paper, parchment paper, paper of greater size, synthetic paper (e.g., polyolefin paper and polystyrene paper), bond paper, art paper, coated paper, cast coated paper, wall paper, backing paper, synthetic resin or emulsion-impregnated paper, synthetic rubber latex-impregnated paper, paper with synthetic resin internally added, paperboard, cellulose fabric paper, or the films of polyester, polyacrylate, polycarbonate, polyurethane, polyimide, polyetherimide, cellulose derivative, polyethylene, ethylene-vinyl acetate copolymer, polypropylene, polystyrene, acryl, polyvinyl chloride, polyvinylidene chloride, polyvinyl alcohol, polyvinyl butyral, nylon, polyether ether ketone, polysulfone, polyether sulfone, tetrafluoro ethylene, perfluoro alkylvinyl ether, polyvinyl fluoride, tetrafluoroethylene/ethylene, tetrafluoroethylene/hexafluoroprbpylene, polychloro trifluoroethylene, and polyvinylidene fluoride. It is possible to use a white opaque film formed by adding a white pigment or filler to these synthetic resins, or a foamed sheet produced by foaming. There is no restriction thereto.

It is also possible to employ a laminate produced by a desired combination of the aforementioned substrates. Typical examples are cellulose fabric paper, and synthetic paper between the synthetic paper or cellulose synthetic paper and plastic film. These substrate sheets can be as thick as desired. They are normally 10 through 300 μm thick.

To achieve a higher degree of printing density and high image quality free of uneven density or a white patch, a layer provided with fine voids is preferred. A plastic film incorporating fine voids and synthetic paper can be used as the layer with fine voids. Further, a layer with fine voids is formed on the substrate sheet of various forms according to various coating methods. Polyolefin, particularly polypropylene, is used as the main component of the plastic film or synthetic paper. This is blended with the inorganic pigment and/or polymer incompatible with polypropylene, and is used as an initiator for void formation. The mixture thereof is oriented and is formed into a plastic film or synthetic paper, which is characterized by excellent cushioning performance, heat insulation, printing sensitivity and resistance to uneven density.

When the aforementioned points are taken into account, the modulus of elasticity of the plastic film and synthetic paper is preferably 5×10⁸Pa to 1×10¹⁰ Pa at a temperature of 20 degrees Celsius. Further, the aforementioned plastic film and synthetic paper are normally produced by biaxial orientation. Accordingly, they are subjected to shrinkage when heated. Their shrinkage is 0.5 through 2.5% when left to stand at a temperature of 110 degrees Celsius for 60 seconds. The aforementioned plastic film and synthetic paper themselves can be formed into a single layer structure containing fine voids or a multiple layer structure constructed of a plurality of layers. In the case of a multiple layer structure, all the constituent layers can contain fine voids or some layers may not contain fine voids. The aforementioned plastic film and synthetic paper can be blended with a whitening agent as a masking agent, if required. To improve whiteness, such an additive as a fluorescent whitening agent may be contained. The layer having fine voids is preferably 30 through 80 μm thick.

As the layer provided with fine voids, a layer with fine voids can be formed on the substrate according to the coating method. The plastic resin to be used includes polyester, urethane resin, polycarbonate, acryl resin, polyvinyl chloride, and polyvinyl acetate. These or other similar resins known in the prior art can be used independently or in a blended form.

To avoid curling; a layer of polyvinyl alcohol, polyvinylidene chloride, polyethylene, polypropylene, modified polyolefin, polyethylene terephthalate, polycarbonate other such resins, and synthetic paper can be arranged on the side opposite to where the substrate receiving layer is arranged, if required. Their lamination method can include such lamination methods known in the prior art as a dry lamination method, non-solvent (hot melt) lamination method and EC lamination method. Of these methods, a dry lamination method and non-solvent lamination method are preferred. An adhesive preferred used in the non-solvent lamination method is exemplified by Takenate 720L by Takeda Chemical Industries, Ltd. An adhesive preferred used in the dry lamination method is exemplified by Takeluck A969/Takenate A-5 (3/1) by Takeda Chemical Industries, Ltd.; and Polyzol PSA SE-1400 and Vinyrol PSA AV-6200 Series by Showa Koubunshi Co., Ltd. The amount of these adhesives to be used is about 1 through 8 grams per square meter in terms of solids, preferably 2 through 6 grams per square meter.

A lamination layer can be used for lamination between plastic film and synthetic resin, between plastic films, between synthetic resins, between various types of paper and plastic film or synthetic paper, described above.

To improve the bonding strength between the aforementioned substrate sheet and pigment receiving layer, the surface of the substrate sheet is preferably provided with various forms of primer treatment and corona discharge treatment.

(Intermediate Layer)

The thermal transfer image receiving sheet may have an intermediate layer arranged between the substrate sheet and pigment receiving layer. The term “intermediate layer” in the sense in which it is used in the present invention refers to all the layers arranged between the substrate sheet and pigment receiving layer. It can be designed in a multiple layer structure. The intermediate layer provides an anti-solvent function, barrier function, adhesion function, whitening function, masking function and antistatic function. Without being restricted thereto, the intermediate layer can provide the functions of all the intermediate layers known in the prior art.

To provide the intermediate layer with an anti-solvent function and barrier function, a water soluble resin is preferably utilized. The water soluble resin is exemplified by cellulose resin such as carboxymethyl cellulose, polysaccharide resin such as starch, protein such as casein, gelatine and agar. The water soluble resin also includes polyvinyl alcohol, ethylene vinyl acetate copolymer, polyvinyl acetate, polyvinyl chloride, vinyl acetate copolymer (e.g., Beopa by Japan Epoxy Resin Co., Ltd. ), vinyl acetate (meth)acryl copolymer, (meth)acryl resin, styrene (meth)acryl copolymer, styrene resin, other vinyl based resins similar to them. The water soluble resin also includes such polyamide based resins as melamine resin, urea resin and benzoguanamine resin; as well as polyester and polyurethane. The water soluble resin in the sense in which it is used here refers to resin that, when exposed to the solvent composed of water as a main component, exhibits the state of complete dissolution (particle size not exceeding 0.01 μm), colloidal dispersion (particle size from 0.01 through 0.1 μm), emulsion (particle size not exceeding 0.1 through 1 μm), or slurry (particle size 1 μm or more). Of these water soluble resins, particularly preferable one is the resin that is not dissolved or swollen when exposed to methanol, ethanol, isopropyl alcohol, other alcohols similar thereto, hexane, cyclohexane, acetone, methyl ethyl ketone, xylene, ethyl acetate, butyl acetate, toluene and other general-purpose solvents similar to them. In this sense, the resin that is completely dissolved in the solvent composed of water as a major component is most preferable. Particularly, polyvinyl alcohol resin and cellulose resin can be mentioned.

To maintain excellent bonding performances of the intermediate layer, a urethane resin or polyolefin resin is generally employed although it may differ according to the type of the substrate sheet and surface treatment thereof. Further, excellent bondability is provided when used in combination with thermoplastic resin containing active hydrogen and curing agent such as isocyanate compound. A fluorescent whitening agent can be used to provide the intermediate layer with a whitening function. Any fluorescent whitening agent known in the prior art can be used. Such fluorescent whitening agents include the one composed of the derivatives of stilbene, distilbene, benzooxazole, styryl-oxazole, pyrene-oxazole, coumalin, aminocoumalin, imidazole, benzoimidazole, pirazoline and distyryl-biphenyl. Whiteness can be adjusted by the type and amount of these fluorescent whitening agents. The fluorescent whitening agent can be added according to any one of the methods such as the method of adding after dissolving the agent in water, the method of adding the agent after pulverizing and dispersing with a ball mill or a colloid mill, the method of adding the agent as an underwater oil drop-like dispersion after dissolving it in a solvent of high boiling point and mixing it with the hydrophilic colloidal solution, and the method of adding by allowing high molecular latex to be impregnated with the agent.

Further, to mask the glare and lack of uniformity, titanium oxide can be added to the intermediate layer. Use of titanium oxide is preferred because it expands the scope of freedom in choosing: the substrate sheet. Titanium oxide is available in two types; rutile and anatase types. When consideration is given to whiteness and the effect of the fluorescent whitening agent, the anatase type titanium oxide is preferred over the rutile type because absorption of ultraviolet is carried out on the shorter wave side in the case of the anatase type titanium oxide. If the binder resin of the intermediate layer is aqueous and titanium oxide does not disperse easily, it is possible to use the titanium oxide whose surface is provided with hydrophilic treatment or to employ the dispersant known in the prior art such as surface active agent and ethylene glycol so as to disperse the titanium oxide. The amount to be added is preferably 10 through 400 parts by mass of solid titanium oxide with respect to 100 parts by mass of solid resin.

To provide the intermediate layer with an antistatic function, a conductive inorganic feeler and an organic conductive material such as polyaniline sulfonic acid can be selected as appropriate and used in conformity to the intermediate layer binder resin known in the prior art. The thickness of the intermediate layer is preferably set within the range from 0.1 through 10 μm.

Referring to the drawing, the following briefly describes the structure of the thermal transfer image receiving sheet in the present invention:

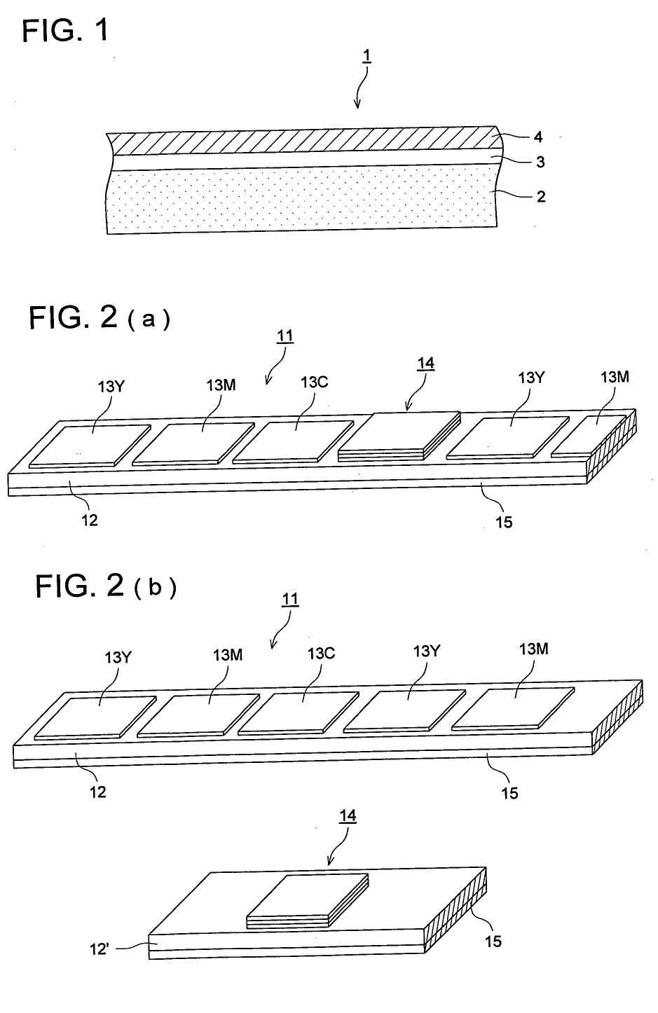

FIG. 1 is a cross sectional view showing an example of the thermal transfer image receiving sheet of the present invention.

In FIG. 1, the thermal transfer image receiving sheet 1 has an intermediate layer 3 on one side of a substrate sheet 2, and a pigment receiving layer 4 is arranged thereon. The aforementioned pigment receiving layer 4 may be structured to have two or more layers.

<<Thermal Transfer Ink Sheet>>

The following describes the thermal transfer ink sheet (hereinafter also referred to as “thermal transfer sheet”) used in combination with the thermal transfer image receiving sheet of the present invention in the image formation method.

(Substrate Sheet)

The material known in the prior art as the substrate sheet of the thermal transfer ink sheet can be used as the substrate sheet used in the thermal transfer ink sheet of the present invention. Specific examples of the preferred substrate sheet include:

thin sheets of glassine paper, capacitor paper and paraffin paper;

polyester characterized by a great resistance to heat such as polyethylene terephthalate, polyethylene naphthalate, polybutylene terephthalate, polyphenylene sulfide, polyether ketone and polyether sulfone;

derivatives of polypropylene, fluoroplastics, polycarbonate, cellulose acetate, and polyethylene; and

plastics such as polyvinyl chloride, polyvinylidene chloride, polystyrene, polyamide, polyimide, polymethyl pentene and ionomer. The preferred substrate sheet includes the oriented or non-oriented films of the aforementioned substances, and laminations of these materials. The thickness of this substrate sheet can be selected so as to ensure adequate strength and heat resistance. Normally, the thickness is preferably about 1 through 100 μm.

If the degree of adhesion with the pigment layer formed on the surface of the substrate sheet is poor, the surface is preferably provided with primer treatment or corona treatment.

(Pigment Layer and Pigment)

The pigment layer (hereinafter also referred to as “ink layer”) constituting the thermal transfer ink sheet of the present invention is preferably a thermally sublimable pigment layer containing at least a pigment and binder resin. One type or a combination of more than one type of pigment can be used with the pigment layer of the present invention.

The following describes the color that can be used in the present invention.

Two or more pigment-containing areas different in hue can be used in the thermal transfer ink sheet in the present invention. This is exemplified by the cases, (1) wherein the pigment-containing area is composed of an area containing a yellow pigment, an area containing a magenta pigment, and an area containing a cyan pigment; and an area not containing any pigment is formed adjacent to these pigment-containing areas; (2) wherein the pigment-containing area is composed of an area containing a black pigment, and an area not containing any pigment is formed adjacent to this pigment-containing area; and (3) wherein the pigment-containing area is composed of an area containing a yellow pigment, an area containing a magenta pigment, an area containing a cyan pigment and an area containing a black pigment; and an area not containing any pigment is formed adjacent to these pigment-containing areas.

The pigment used in the thermally sublimable pigment layer is also used in the thermal transfer ink sheet based on the thermally-sensitive sublimable transfer method known in the prior art. All types of pigments including derivatives of azo, azomethine, methine, anthraquinone, quinophthalone and naphtoquinone can be mentioned, without any particular restriction thereto. To put it more specifically, the yellow pigment includes Phorone Brilliant Yellow 6GL, PTY-52, and Macrorex Yellow 6G. The red pigment includes MS Red G, Macrorex Red Violet R, Ceres Red 7B, Samaron Red HBSL and SK Rubin SEGL. The blue pigment includes Kayaset Blue 714, Wacsoline Blue AP-FW, Phorone Brilliant Blue S-R, MS Blue 100 and Dyte Blue No. 1.

The following describes the chelating pigment used for formation of the aforementioned post-chelating type sublimable image:

The chelating cyan pigment will be described first.

The chelating cyan pigment includes the compound defined by the following general formula:

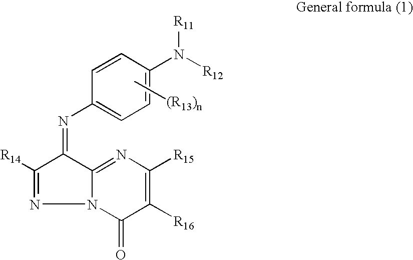

In the aforementioned general formula (1), R₁₁, R₁₂ and R₁₃ denote the non-aromatic hydrocarbon groups. R₁₁, R₁₂ and R₁₃ can be either the same or different from each other. For example, alkyl, cycloalkyl, alkenyl, alkynyl groups can be mentioned. The alkynyl group includes methyl, ethyl, propyl and i-propyl groups. The group that can replace these alkyl groups includes straight chain or branched chain alkyl group (e.g., methyl, ethyl and i-propyl, t-butyl, n-dodecyl and 1-hexylnonyl groups), cycloalkyl group (e.g., cyclopropyl, cyclohexyl, bicyclo [2.2.1] heptyl, and adamantyl groups), alkenyl group (e.g., 2-propylene and oleyl groups), aryl group (e.g., phenyl, ortho-tolyl, ortho-anisyl, 1-naphthyl and 9-anthranyl group), heterocyclic group (e.g.; 2-tetrahydrofuryl, 2-thiophenyl, 4-imidazolyl, 2-pyridyl groups), halogen atom (e.g., fluorine, chlorine, bromine atoms), cyano group, nitro group, hydroxyl group, carbonyl group (e.g., alkyl carbonyl group such as acetyl, trifluoro acetyl and pivaloyl groups; and aryl carbonyl group such as benzoyl, pentafluoro benzoyl and 3,5-di-t-butyl-4-hydroxybenzoyl groups), oxycarbonyl group (e.g., alkoxycarbonyl group such as methoxycarbonyl and cyclohexyloxycarbonyl and n-dodecyloxy carbonyl groups; aryloxycarbonyl group such as phenoxycarbonyl, 2,4-di-t-amylphenoxycarbo nyl and 1-naphthyloxycarbonyl groups; and heterocyclic oxycarbonyl group such as 2-pyridyloxycarbonyl and 1-phenylpirazolyl-5-oxycarbonyl groups), carbamoyl group (e.g., alkyl carbamoyl group such as dimethylcarbamoyl group and 4-(2-,4-di-t-amylphenoxy) butylaminocarbonyl group; and arylcarbamoyl group such as phenylcarbamoyl and 1-naphthylcarbamoyl groups), alkoxy group (e.g., methoxy and 2-ethoxyethoxy groups), aryloxy group (e.g., phenoxy, 2,4-di-t- amylphenoxy and 4-(4-hydroxyphenylsulfonyl) phenoxy groups), heterocyclic oxy group (e.g., 4-pyridyloxy and 2-hexahydropyranyloxy groups), carbonyloxy group (e.g., alkylcarbonyl group such as acetyloxy, trifluoroacetyloxy and pivaloyloxy groups; and arylcarbonyloxy group such as benzoyloxy and pentafluorobenzoyloxy groups), urethane group (e.g., alkylurethane group such as N,N-dimethyl urethane; and arylurethane group such as N-phenylurethane and N-(p-cyanophenyl) urethane groups), sulfonyl group (e.g., alkylsulfonyloxy group such as methane sulfonyloxy, trifluoromethanesulfonyloxy and n-dodecanesulfonyloxy groups; and arylsulfonyloxy group such as benzene sulfonyloxy and p-toluene sulfonyloxy groups), amino group (e.g., alkylamino group such as dimethylamino, cyclohexylamino and n-dodesylamino groups; and arylamino group such as anilino and p-t-octylanilino groups), sulfonylamino group (e.g., such as methanesulfonylamino, heptafluoropropanesulfonylamino and n-hexadesylsulfonylamino groups; and arylsulfonylamino such as p-toluene sulfonylamino and pentafluorobenzenesulfonylamino), sulfamoylamino group (e.g., alkylsulfamoylamino group such as N,N-dimethylsulfamoylamiho group; and arylsulfamoylamino group such as N-phenylsulfamoylamino group), acylamino group (e.g., alkylcarbonylamino group such as acetylamino and myristoylamino groups; and arylcarbonylamino group such as benzoylamino group), ureide group (e.g., alkylureide group such as N,N-dimethylaminoureide; and aryl ureide group such as N-phenylureide and N-(p-syanophynyl) ureide groups), sulfonyl group (e.g., alkylsulfbnyl group such as methanesulfonyl and trifluoromethanesulfonyl groups; and arylsulfonyl group such as p-toluene-sulfonyl group), sulfamoyl group (e.g., alkylsulfamoyl group such as dimethylsulfamoyl and 4-(2,4-di-t-amylphenoxy) butylaminosulfamoyl groups; and arylsulfamoyl group such as phenylsulfamoyl group), alkylthio group (e.g., mehtylthio group and t-octylthio group), arylthio group (e.g., phenylthio group), and heterocyclic thio group (e.g., 1-phenyltetrazole-5-thio group and 5-methyl-1,3,4-oxadiazole-2-thio group).

The cycloalkyl group and alkenyl group are exemplified by what have already been mentioned as examples of the substituents of the alkyl group. The alkynyl group is exemplified by 1-propyne, 2-butyne and 1-hexyne.

R₁₁ and R₁₂ are preferably bonded with each other to form a non-aromatic cyclic structure (e.g., pyrrolidine ring, piperidine ring and morpholine ring).

R₁₃ is preferred to be an alkyl group or cycloalkyl group, out of the aforementioned a non-aromatic hydrocarbon. “n” denotes an integer from 0 through 4. When “n” is equal to or greater than 2, a plurality of R₁₃ are the same with one another or different from one another.

R₁₄ denotes an alkyl group, and includes methyl, ethyl, i-propyl, t-butyl, n-dodesyl, and 1-hexylnonyl groups. R₁₄ is preferably a secondary or tertiary alkyl group. The preferred secondary or tertiary alkyl group is exemplified by isopropyl, sec-butyl, tert-butyl and 3-heptyl groups. The most preferred substituent for the R₁₄ is represented by isopropyl and tert-butyl groups. The alkyl group of the R₁₄ can be replaced. It is entirely replaced by a substituent composed of carbon atoms and hydrogen atoms, and not by a substituent including other atoms.

The R₁₅ is an alkyl group, and is exemplified by n-propyl, i-propyl, t-butyl, n-dodesyl, and 1-hexylnonyl groups. R₁₅ is preferably a secondary or tertiary alkyl group. The preferred secondary or tertiary alkyl group is exemplified by isopropyl, sec-butyl, tert-butyl and 3-heptyl groups. The most preferred substituent for the R₁₅ is represented by isopropyl and tert-butyl groups. The alkyl group of the R₁₅ can be replaced. It is entirely replaced by a substituent composed of carbon atoms and hydrogen atoms, and not by a substituent including other atoms.

R₁₆ denotes an alkyl group, and is exemplified by n-propyl, n-butyl, n-pentyl, n-hexyl, n-heptyl, isopropyl, sec-butyl, tert-butyl and 3-heptyl groups. The particularly preferred substituent for the R₁₆ is a straight chain alkyl group having a carbon number of 3 or more, and is exemplified by n-propyl, n-butyl, n-pentyl, n-hexyl and n-heptyl groups. The most preferred groups are n-propyl and n-butyl groups. The alkyl group of the R₁₆ can be replaced. It is entirely replaced by a substituent composed of carbon atoms and hydrogen atoms, and not by a substituent including other atoms.

The following describes the chelate yellow pigment:

The chelate yellow pigment includes the compounds defined by the following general formula (2):

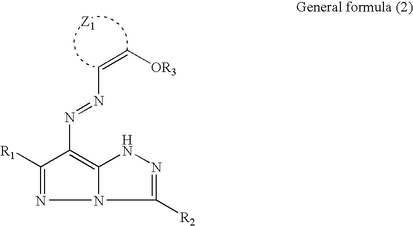

In the general formula (2), R₁ and R₂ represent substituents.

For example, a halogen atom, alkyl group (alkyl group having a carbon number of 1 through 12; the substituent linked by an oxygen atom, nitrogen atom, sulfur atom or carbonyl group can be replaced, or aryl group, alkenyl group, alkynyl group, hydroxyl group, amino group, nitro group, carboxyl group, cyano group, or halogen atom can be replaced; this alkyl group including methyl, isopropyl, t-butyl, trifluoromethyl, methoxymethyl, 2-methanesulfonylethyl and 2-methanesulfoneamidoethyl groups), cycloalkyl group (e.g., cyclohexyl group), aryl group (e.g., phenyl, 4-t-butylphenyl, 3-nitrophenyl, 3-acylaminophenyl and 2-methoxyphenyl groups), cyano group, alkoxy group, aryloxy group, acylamino group, anilino group, ureide group, sulfamoylamino group, alkylthio group, arylthio group, alkoxycarbonylamino group, sulfoneamide group, carbamoyl group, sulfamoyl group, sulfonyl group, alkoxycarbonyl group, heterocyclic oxy group, acyloxy group, carbamoyloxy group, silyloxy group, aryloxycarbonylamino group, imido group, heterocyclic thio group, phosphonyl group and acyl group.

The alkyl group, cycloalkyl group and aryl group represented by R₃ are exemplified by the same substances as the alkyl group, cycloalkyl group and aryl group represented by the R₁ and R₂.

A 5- or 6-membered aromatic ring formed together with two carbon atoms expressed by Z, includes benzene, pyridine, pyrimidine, triazine, pyrazine, pyridazine, pyrrole, furan, thiophene, pyrazole, imidazole, triazole, oxazole and thiazole rings. Such a ring may form a condensed ring with another aromatic ring. A substituent may be arranged on such a ring. This substituent can be the same as the substituent denoted by R₁ and R₂.

The following describes the chelate magenta pigment:

The chelate magenta pigment includes the compounds defined by the following general formula (3):

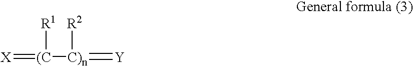

In the general formula (3), “X” denotes a collection of the groups or atoms capable of at least bidentate chelating. “Y” represents a collection of atoms capable of forming 5- or 6-membered aromatic hydrocarbon ring or heterocyclic ring. R₁ and R₂ each indicate hydrogen atom or monovalent substituent. “n” indicates 0, 1 and 2.

“X” shows a particularly preferred group defined by the following general formula (4):

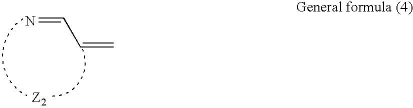

In the aforementioned general formula (4), Z₂ denotes a group of atoms required to form an aromatic nitrogen-containing heterocyclic ring replaced by the group containing at least one nitrogen atom capable of chelation. These rings may form a condensed ring with other carbon ring (benzene ring, etc.) and heterocyclic ring (pyridine ring, etc.).

In the aforementioned general formula (3), “X” denotes the groups or atoms capable of at least bidentate chelating. The preferred examples are 5-pyrazolone, pyridine, pyrimidine, thiazole, imidazole, pyrazolopyrrole, pyrazolopyrazole, pyrazoloimidazole, pyrazolotriazole, pyrazolotetrazole, barbituric acid, thiobarbituric acid, rhodanine, hydantoinl thiohydantoin, oxazolone, isooxazolone, indandione, pyrazolidinedione, oxazolidinedione, hydroxypyridone or pyrazolopyridone.

“Y” denotes a collection of atoms forming a five- or six-membered aromatic maintain hydrocarbon ring. A further substituent or condensed ring may be arranged on this ring.

Specific examples of this ring include 3H-pyrrole ring, oxazole ring, imidazole ring, 3H-pyrrolidine ring, oxazolidine ring, imidazolidine ring, thiazolidine ring, 3H-indole ring, benzoxazole ring, thiazole ring, benzimidazole ring, benzothiazole ring, quinoline ring and pyridine ring. These rings may form a condensed ring with other carbon rings (e.g., benzene ring) and heterocyclic ring (e.g., pyridine ring). The substituent on the ring is represented by alkyl group, aryl group, hetero group, acyl group, amino group, nitro-group, cyano group, acylamino group, alkoxy group, hydroxyl group, alkoxycarbonyl group and halogen atom. These groups can be replaced further.

R¹ and R² each denote a hydrogen atom or mIonovalent substituent. The monovalent substituent includes a halogen atom (e.g., fluorine atom and chlorine atom), alkyl group, alkoxy group, cyano group, alkoxycarbonyl group, aryl group, heterocyclic group, carbamoyl group, hydroxyl group, acyl group and acylamino group.

(Binder Resin)

In the present invention, the ink layer contains the binder resin together with the aforementioned pigment.

The binder resin used for the thermal transfer ink sheet based on the thermally-sensitive sublimable transfer method known in the prior art can be used as the binder resin for the ink layer. For example, it includes:

water soluble polymer such as the derivatives of cellulose, polyacrylic acid, polyvinyl alcohol and polyvinylpyrrolidone; and

polymer soluble in organic solvent such as acryl resin, methacryl resin, polystyrene, polycarbonate, polysulfone, polyethersulfone, polyvinyl butyral, polyvinylacetal, ethylcellulose and nitrocellulose. Of these resins, polyvinyl butyral, polyvinylacetal or cellulose resin characterized by excellent keeping quality is preferably used.

Without being restricted to any specific value, the amounts of pigment and binder resin in the ink layer is preferably determined as appropriate, with consideration given to satisfactory performances.

The ink layer of the present invention can contain various additives known in the prior art, in addition to the aforementioned pigment and binder resin, as required. To form the ink layer, the ink coating solution prepared by dissolving or dispersing the aforementioned pigment, binder resin and other additives in a solvent are coated on the substrate sheet according to the gravure coating method and other methods known in the prior art, and are dried. The ink layer of the present invention has a thickness of about 0.1 through 3.0 μm. preferably 0.3 through 1.5 μm.

(Protective Layer and Transferable Protective Layer)

The thermal transfer ink sheet of the present invention is preferably provided with a thermal-transferable protective layer. This thermal-transferable protective layer (also called a protective layer or transferable protective layer) is composed of a transparent resin layer as a protective layer for covering the surface of the image formed by thermal transfer onto the thermal transfer image receiving sheet.

The resin used to form the protective layer includes polyester resin, polystyrene resin, acryl resin, polyurethane resin, acrylurethane resin, polycarbonate resin, epoxy modified resins of these resins, resins formed by silicone modification of these resins, mixtures of these resins, resins cured by ionizing radiation and ultraviolet-screening resin. Resins preferably used are polyester resin, polycarbonate resin, epoxy modified resin, and resins cured by ionizing radiation. The preferred polyester resin includes alicyclic polyester resin having an alicyclic compound containing one or more types of diol component and acid component. The preferred polycarbonate resin includes aromatic polycarbonate resin. The aromatic polycarbonate resin disclosed in the Official Gazette of Japanese Patent Tokkaihei 11-151867 is preferred in particular.

The epoxy modified resin includes epoxy modified urethane, epoxy modified polyethylene, epoxy modified polyethylene terephthalate, epoxy modified polyphenylsulfite, epoxy modified cellulose, epoxy modified polypropylene, epoxy modified polyvinyl chloride, epoxy modified polycarbonate, epoxy modified acryl, epoxy modified polystyrene, epoxy modified polymethylmethacrylate, epoxy modified silicone, copolymer between epoxy modified polystyrene and epoxy modified polymethylmethacrylate, copolymer between epoxy modified acryl and epoxy modified polystyrene, and copolymer between epoxy modified acryl and epoxy modified silicone. Preferably used ones are epoxy modified acryl, epoxy modified polystyrene, epoxy modified polymethylmethacrylate, and epoxy modified silicone. More preferably used ones are copolymer between epoxy modified polystyrene and epoxy modified polymethylmethacrylate, copolymer between epoxy modified acryl and epoxy modified polystyrene, and copolymer between epoxy modified acryl and epoxy modified silicone.

(Resin Cured by Ionizing Radiation)

A resin cured by ionizing radiation can be used as the thermal-transferable protective layer. When this resin is contained in the thermal-transferable protective layer, resistance to plasticizer and abrasion is improved. The resin cured by ionizing radiation known in the prior art can be used. For example, radical polymerized polymer or oligomer is cross-linked and cured by ionizing radiation, and photo-polymerization initiator is added as required. This is polymerized and cross-linked by an electron beam and ultraviolet beam. This resulting substrate can be used as the thermal-transferable protective layer.

(Ultraviolet-Screening Resin) The protective layer containing an ultraviolet-screening resin is mainly intended to provide a printed material with light resistance. The resin obtained by causing a reactive ultraviolet absorber to react and bond with the thermoplastic resin or the aforementioned resin cured by ionizing radiation can be used as the ultraviolet-screening resin. Specific examples include the substance produced by introducing such a reactive group as the addition polymerized double bond (e.g., vinyl group, acryloyl group and methacroyl group), alcoholic hydroxyl group, amino group, carboxyl group, epoxy group or isocyanate group, into non-reactive organic ultraviolet absorber known in the prior art, such as derivatives of salicilate, benzophenone, benzotriazole, substitutional acrylonytryl, nickel chelate and hindered amine.

The main protective layer provided in the thermal-transferable protective layer of simple-layer structure or the thermal-transferable protective layer of multi-layer structure as described above, is normally formed to a thickness of about 0.5 through 10 μm, although the thickness depends on the type of the resin forming the protective layer.

In the present invention, the thermal-transferable protective layer is preferably arranged on the substrate through not-transfer mold releasing layer.

In order to ensure that the adhesive strength between the substrate sheet and non-transfer mold releasing layer is always kept sufficiently higher than that of the non-transfer mold releasing layer and non-transferable protective layer, and the non-transfer mold releasing layer and non-transferable protective layer prior to application of heat is higher than that subsequent to application of heat, the non-transfer mold releasing layer preferably contains:

(1) 30 through 80% by mass of inorganic particles having an average particle size of 40 nm or less, together with the resin binder;

(2) a total of 20% or more by mass of copolymer between alkylvinylether and maleic anhydride, derivative thereof, or mixture thereof;

(3) 20% or more by mass of ionomer. The non-transfer mold releasing layer may contain other additives, as required.

The examples of inorganic particles are silica fine particles such as silica anhydride and colloidal silica, and metal oxide such as tin oxide, zinc oxide and zinc antimonate. To ensure transparency of the protective layer, the particle size of the inorganic particles is preferably 40 nm or less.

There is no restriction to the resin binder mixed with the inorganic particle. Any resins that can be blended may be used. The examples are polyvinyl alcohol (PVA) of various degrees of saponification; polyvinylacetal resin; polyvinylbutyral resin; acryl resin; polyamide resin; cellulose resin such as cellulose acetate, alkylcellulose, carboxymethyl cellulose and hydroxyalkyl cellulose; and polyvinylpyrrolidone resin.

The blending ratio between the inorganic particles and other mixture components mainly composed of resin binders (inorganic particles/other components) is preferably 30/70 or more without exceeding 80/20 in terms of mass ratio for the purpose of film formation.

The copolymer wherein the alkyl group of the alkylvinylether is methyl group or ethyl group, and the maleic anhydride is partly or wholly the half-ester with the alcohol (e.g., methanol, ethanol, propanol, isopropanol, butanol, and isobutanol), for example, can be used as the copolymer between alkylvinylether and maleic anhydride or derivative thereof.

The mold releasing layer can be formed only by copolymer between alkylvinylether and maleic anhydride, derivative thereof, or mixture thereof. To adjust the force of separation between the mold releasing layer and protective layer, other resins and fine particles can be added. In this case, the mold releasing layer is preferred to include 20% or more by mass of copolymer between alkylvinylether and maleic anhydride, derivative thereof, or mixture thereof.

There is no restriction to the resin or fine particles to be blended with the copolymer between alkylvinylether and maleic anhydride or derivative thereof. Any material can be used if it can be blended and it has a high degree of film transparency at the time of film formation. For example, a resin binder blendable with the aforementioned inorganic fine particles and inorganic fine particles is preferably utilized.

For example, Surlyn A (by DuPont) and Chemipearl S series (Mitsui Petrochemical Industries, Ltd.) can be used as an ionomer resin. The aforementioned inorganic fine particles, resin binder blendable with the inorganic fine particles, or other resin and fine particles can be further added to ionomer.

To form a non-transfer mold releasing layer, a coating solution containing the components of any of the aforementioned (1) through (3) at a blending ratio is prepared. This coating solution is coated on the substrate sheet according to the technique known in the prior art such as a gravure coating method, and the coated layer is dried. The thickness of the non-transfer mold releasing layer is normally about 0.1 through 2 μm after having been dried.

The thermal-transferable protective layer laminated on the substrate sheet through the non-transfer mold releasing layer or directly may be designed in a multi-layer structure or in a single-layer structure. When the multi-layer structure is used, the adhesive layer arranged on the extreme surface of the thermal-transferable protective layer in order to increase the bondability between the thermal-transferable protective layer and the image receiving surface of the printed material, auxiliary protective layer, and a layer for providing other than the inherent functions of the protective layer (e.g., anti-counterfeiting layer and hologram layer) can be arranged in addition to the main protective layer for providing an image with durability of various forms. The main protective layer and other layers can be provided in any desired order. Normally, the adhesive layer and main protective layer are laid out so that the main protective layer is located on the extreme surface of the image receiving layer after transfer.

An adhesive layer may be formed on the extreme surface of the thermal-transferable protective layer. The adhesive layer can be formed of the resin exhibiting a satisfactory bondability at the time of heating, such as acryl resin, polyvinyl chloride resin, vinyl acetate resin, copolymer resin between polyvinyl chloride and vinyl acetate resin, polyester resin and polyamide resin. Further, in addition to the aforementioned resin, the aforementioned resin cured by ionizing radiation and ultraviolet-screening resin can be blended as required. The adhesive layer normally has a thickness of 0.1 through 5 μm.

To form a thermal-transferable protective layer on the non-transfer mold releasing layer or substrate sheet, the protective layer coating solution containing a protective layer forming resin, adhesive layer coating solution containing a thermally adhesive resin, and coating solution for forming other layers to be added as required are prepared in advance. They are coated on the non-transfer mold releasing layer or substrate sheet in a predetermined order, and are dried. Each coating-solution can be coated according to the method known in the prior art. Further, an adequate primer layer can be arranged between layers.

<Ultraviolet Absorber>

An ultraviolet absorber is preferably contained in on at least one of the thermal-transferable protective layers. When it is contained in a transparent resin layer, the transparent resin layer is located on the extreme surface after transfer onto the protective layer. This may deteriorate the advantages with the lapse of time under the adverse effect of the environment and other factors. To prevent this, it is particular preferred that it should be contained in the thermally-sensitive adhesive layer.

The examples of ultraviolet absorber are the derivatives of salicylic acid, benzophenone, benzotriazole, and cyanoacrylate. They are available on the market-under the trademark of Tinuvin P, Tinuvin 234, Tinuvin 320, Tinuvin 326, Tinuvin 327, Tinuvin 328, Tinuvin 312 and Tinuvin 315 (Chiba Geigie Inc.); Sumisorb-110, Sumisorb-130, Sumisorb-140, Sumisorb-2,00, Sumisorb-250, Sumisorb-300, Sumisorb-320, Sumisorb-340, Sumisorb-350, and Sumisorb-400 (by Sumitomo Chemical Co., Ltd.); Mark LA-32i Mark LA-36 and Mark 1413 (Adeca Agas Kagaku Inc.). They can be used in the present invention.

It is possible to utilize a random copolymer formed by random copolymerization between the reactive ultraviolet absorber and acryl monomer, at a temperature of Tg 60 degrees Celsius or more, preferably Tg 80 degrees Celsius or more.

The aforementioned reactive ultraviolet absorber includes the one prepared by introducing the addition polymerized double bond of vinyl group, acryloyl group and methacryloyl group, or alcohol-based hydroxyl group, amino group, carboxyl group, epoxy group and isocyanate group, into the known non-reactive ultraviolet absorber such as the known derivatives of salicilate, benzophenone, benzotriazole, substitutional acrylonytryl, nickel chelate and hindered amine. Specific examples are available on the market under the tradename of UVA635L and UVA633L (by BASF Japan) or PUVA-30M (by Ohtsuka Kagaku Co., Ltd.). Any of them can be used in the present invention.

In the random copolymer between reactive ultraviolet absorber and acryl monomer, the amount of reactive ultraviolet absorber is 10 through 90 percent by mass, preferably 30 through 70 percent by mass. The molecular weight of such a random copolymer can be 5,000 through 250,000, preferably 9,000 through 30,000. The aforementioned ultraviolet absorber, and the random copolymer between reactive ultraviolet absorber and acryl monomer may each be contained independently. The amount of the random copolymer between reactive ultraviolet absorber and acryl monomer to be added is preferably 5 through 50 percent by mass with respect to the layer for containing the same.

In addition to the ultraviolet absorber, other light proofing agent can be contained. The light proofing agent in the sense in which it is used here refers to the chemical that absorbs or blocks the process of degenerating or decomposing a pigment through optical energy, heat energy and oxidation process, thereby avoiding degeneration or decomposition of the pigment. The specific example include the light stabilizer known in the prior art as the addition of synthetic resin, in addition to the aforementioned ultraviolet absorber. In this case as well, it can be contained in at least one of the thermal-transferable protective layers, namely, at least one of the aforementioned stripping layer, transparent resin layer and thermally-sensitive adhesive layer. It is preferably contained in the thermally-sensitive adhesive layer in particular.

Although there is no particular restriction, the amount of the light proofing agent including the aforementioned ultraviolet absorber is preferably 0.05 through 10 by mass, preferably 3 through 10 parts by mass, with respect to 100 parts by mass of the resin forming the layer for containing it, with consideration given to the advantages and economy of the light proofing agent.

In addition to the aforementioned light proofing agent, various forms of additives such as a fluorescent whitening agent and a filler can be added to the adhesive layer in the proper amount.

The transparent resin layer of the protective layer transfer sheet can be provided independently on the substrate sheet, or can be provided frame-sequentially with the pigment layer of the thermal transfer ink sheet.

(Heat-Resistant Slipping Layer)

In the thermal transfer ink sheet of the present invention, the heat-resistant slipping layer is preferably arranged on the surface opposite to the pigment layer with the substrate sheet located in-between.

The heat-resistant slipping layer ensures that thermal fusion does not occur between the heating device such as a thermal head and substrate sheet, whereby smooth traveling is provided. At the same time, the heat-resistant slipping layer removes depositions from the thermal head.

Resins used in the heat-resistant slipping layer include cellulose based resins such as ethyl cellulose, hydroxy cellulose, hydroxypropyl cellulose, methyl cellulose, cellulose acetate, cellulose acetate butyrate and nitro cellulose; vinyl based resins such as polyvinyl alchol, polyvinyl acetate, polyvinyl butyral, polyvinyl acetal and polyvinyl pyrrolidone; acryl based resins such as polymethyl methacrylate, polyethyl acrylate, polyacrylamide and acrylonitryl-styrene copolymer; polyimide resin, polyamide resin, polyamideimide resin, polyvinyl toluene resin, coumarone indene resin, polyester resin, polyurethane resin and silicone modified or fluorine modified urethane. Single substances or mixtures of the aforementioned natural or synthetic resins are used in the heat-resistant slipping layer. To further improve the heat resistance of the heat-resistant slipping layer, the aforementioned resins having a reactive hydroxyl group are preferably used and polyisocyanate is preferably used in combination as a cross-linking agent, whereby a cross-linked resin layer is formed.

Further, to provide satisfactory sliding with the thermal head, a solid or liquid mold releasing agent or lubricant can be applied to the heat-resistant slipping layer, thereby ensuring heat-resistant slipping property. The mold releasing agent or lubricant that can be used includes waxes such as a polyethylene wax and paraffin wax; higher aliphatic alcohol, organopolysiloxane, anion surface active agent, cation surface active agent, ampholytic surface active agent, nonion surface active agent, fluorine surface active agent, metallic soap, organic carboxylic acid, and derivatives thereof; and an inorganic compound such as fluorine resin, silicone resin, talc and silica. Fine particles of these substances can be used as the mold releasing agent or lubricant. The amount of the lubricant contained in the heat-resistant slipping layer is 5 through 50 percent by mass, preferably 10 through 30 percent by mass. The thickness of the heat-resistant slipping layer is about 0.1 through 10 μm, preferably 0.3 through 5 μm.

The following describes the specific examples of the structure of the thermal transfer ink sheet of the present invention with reference to drawings:

FIG. 2 is a perspective view representing an example of the thermal transfer ink sheet of the present invention.

FIG. 2(a) is a perspective view representing an embodiment of the thermal transfer ink sheet of the present invention supplied according to frame sequential method. In FIG. 2(a), the thermal transfer ink sheet 11 has ink layers 13Y, 13M and 13C corresponding to the yellow (Y), magenta (M) and cyan (C) pigments formed on the plane flush with a support member 12. A transferable protective layer 14 is arranged frame-sequentially in the area separately from this ink layer. Further, the other surface of the support member 12 is provided with a back layer (heat-resistant slipping layer) 15.

FIG. 2(b) is a perspective view showing an example of the case wherein the transferable protective layer 14 is arranged on a support member 12′ different from the support member 12 provided with ink layers 13Y, 13M and 13C of the thermal transfer ink sheet 11. This is a preferred embodiment of the present invention.

In FIGS. 2(a) and (b), there is a slight gap between ink layers or between transferable protective layers 14. This gap can be adjusted as appropriate, while following the control method of the thermal transfer image receiving apparatus. To improve the precision in locating the start of each ink layer, a detection mark is preferably provided on the thermal transfer sheet. There is no particular restriction to the procedure of providing the detection mark. In FIG. 2, the ink layer and transferable protective layer or area for post-heat treatment is arranged on the surface flush with the substrate sheet. It goes without saying that each layer can be arranged on a separate support member. When a reactive pigment is used in each ink layer, the pigment per se contained in the ink layer is a compound prior to reaction. Strictly speaking, it cannot be said to be Y, M or C pigment. However, the same expression will be employed for the sake of expediency, in the sense that it is a layer for creating Y, M and C images in the final phase.

<<Image Formation Method>>

The following describes the image formation method of the present invention.

In the image formation method of the present invention, the thermal transfer image receiving sheet of the present invention and the thermal transfer ink sheet containing the thermal diffusible pigment are placed one on top of the other, and they are heated in response to a recording signal, whereby the thermal diffusible pigment containing the thermal transfer ink sheet is transferred onto the thermal transfer image receiving sheet. This procedure allows an image to be formed. This structure provides sufficient printing density in high-speed printing as well.

The printing speed will be discussed first.

The printing speed in the present invention indicates printing time per dot. When the following thermal head and heating roller are used for heating, the printing speed is expressed in printing speed (msec./line) per line. The normal printing speed is 2 through 5 msec./line. It is preferably 1.5 msec./line or less when the advantages intended in the present invention are to be, achieved. The printing speed can be as close as possible to zero (0), but the lower limit is 0.05 msec./line when consideration is given to the control level of the aforementioned thermal transfer recording apparatus and various practical purposes.

The following describes the image information method in the present invention.

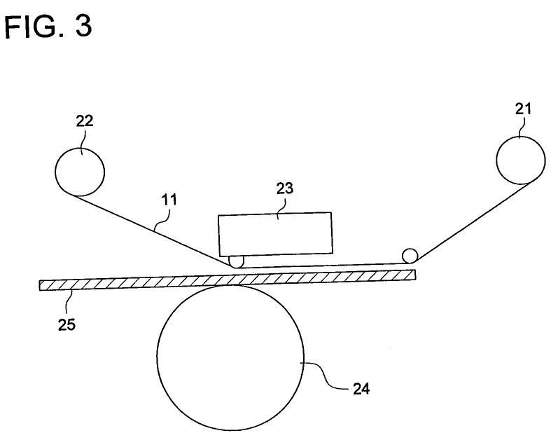

For example, the thermal transfer recording apparatus shown in FIG. 3 can be employed. In FIG. 3, reference numeral 21 denotes a thermal transfer ink sheet supply roll, 11 indicates a thermal transfer ink sheet, 22 shows a take-up roll for taking up the thermal transfer ink sheet 11, 23 represents a thermal head, 24 shows a platen roller, and 25 denotes a thermal transfer image receiving sheet inserted between the thermal head 23 and platen roller 24.

Employing the thermal transfer recording apparatus shown in FIG. 3, the following describes the process of forming an image using the thermal transfer ink sheet shown in FIG. 2(a). In the first plate, the ink layer 13Y containing the yellow pigment of the thermal transfer ink sheet in FIG. 2(a) and the pigment receiving layer of the thermal transfer image receiving sheet 25 are placed one on top of the other. The yellow pigment in the ink layer 13Y is transferred onto the image receiving sheet by the thermal printing of the thermal head 23 according to the image data, whereby the yellow image is formed. Then in the similar manner, the magenta pigment is transferred onto the yellow image from the ink layer 13M containing the magenta pigment. Then ink layer 13C containing the cyan pigment is transferred on this transferred image in the similar manner. In the final phase, the transferable protective layer 14 containing the transferable protective layer is thermally transferred onto the entire surface of this image from the thermal transfer sheet, whereby an image is formed.

In the thermal transfer recording apparatus used in the present invention, selection between gloss control and matt control is preferably provided within one and the same apparatus, because a printed material having a desired surface can be obtained from one and the same apparatus. There is no particular restriction to the method of selection. For example, it is possible to arrange such a configuration that the control data corresponding to the gloss control and matt control of the present invention is stored in the thermal transfer recording apparatus. The control data selected by a simple operation by the operator is scanned. Then the control section is controlled according to this data. Alternatively, it is also possible to arrange such a configuration that, when a PC is connected to the recording apparatus, the control data is stored in the PC, and the control data selected by a simple operation by the operator is fed to the recording apparatus. Further, when a heating roller is used for heating, the material for altering the quality of the surface—e.g., a mold releasing sheet for improving glossiness or a sheet having a concavo-convex pattern for matt control—is applied to the surfaced of the receiving layer prior to image recording. Then heating is provided by the heating roller from the back of the sheet, whereby records having different surfaces can be obtained.

### EXAMPLE

The following specifically describes the present invention with reference to embodiments, without the prevent invention being restricted thereto. In the embodiments, “parts” refers to “parts by mass”, and “percent” refers to “percent by mass”, unless otherwise specified.

### Embodiment 1

<<Manufacturing the Thermal Transfer Ink Sheet 1>>

A coating solution for the heat-resistant slipping layer composed of the following compositions was coated by the gravure coating method on one of the surfaces of a polyethylene terephthalate film (manufactured by Mitsubishi Chemical Polyester Co., Ltd.) having a thickness of 6 μm, the aforementioned surface being located opposite to the surface having undergone adhesion promoting treatment. Then the film was dried and was subjected to thermal curing treatment, thereby producing a substrate sheet for the thermal transfer ink sheet having a heat-resistant slipping layer with a dry film thickness of 1.0 μm.

(Heat-resistant slipping layer coating solution)

| | |
|---|---|
| Polyvinyl butyral resin (Esrex BX-1 by Sekisui | 3.5 parts by mass |
| Chemical Co., Ltd.): | |
| Phosphoric acid ester surface active agent (Plyserf | 3.0 parts by mass |
| A208S by Daiichi Kogyo Seiyaku Co., Ltd.): | |
| Phosphoric acid ester surface active agent (Phosphanol | 0.3 parts by mass |
| RD720 by Toho Chemical Industry Co., Ltd.): | |
| Polyisocyanate (Barnox D750-45 by Dai Nippon Ink | 9.0 parts by mass |
| and Chemicals., Inc.) | |
| Talc (Y/X = 0.03 by Nippon Talc Co., Ltd.): | 0.2 parts by mass |
| Methyl ethyl ketone: | 35 parts by mass |
| Toluene: | 35 parts by mass |

[Preparing and Applying the Transferable Protective Layer Coating Solution]

A mold releasing layer coating solution composed of the following compositions was coated by the gravure coating method on the protective layer area on the surface of the substrate sheet produced in the aforementioned procedure, the aforementioned surface being located opposite to the surface provided with the heat-resistant slipping layer, in such a way that a dry film thickness would be 1.0 μm. Then the sheet was dried, thereby producing a mold releasing layer. Further, the protective layer coating solution having the following composition was coated on the mold releasing layer so that the dry film thickness would be 2.0 μm. Then the layer was dried to form a sheet having a transferable protective layer.

(Mold releasing layer coating solution)

| | |
|---|---|
| Polyurethane (Hydran AP-40 by Dai Nippon Ink and | 5.0 parts by mass |
| Chemicals., Inc.): | |
| Polyvinyl alcohol resin (Gosenol by Nippon | 8.0 parts by mass |
| Synthetic Chemicals Industry Co., Ltd.): | |
| Water: | 80.0 parts by mass |
| Ethanol: | 80.0 parts by mass |

(Protective layer coating solution)

| | |
|---|---|
| Copolymer resin produced by reaction and bonding | 2.5 parts by mass |
| of the reactive ultraviolet absorber (UVA635L by | |
| BASF Japan Co., Ltd.): | |
| Acryl resin (Dianal BR83 by Mitsubishi Rayon Co., | 15.0 parts by mass |
| Ltd.): | |
| Methyl ethyl ketone: | 100.0 parts by mass |

[Preparing and Applying the Ink Layer Coating Solution]

The yellow ink coating solution 1, magenta ink coating solution 1 and cyan ink coating solution 1 which were ink coating solutions of yellow (Y), magenta (M) and cyan (C) composed of the following compositions were applied frame-sequentially according to the gravure coating method on the surface of the sheet manufactured according to the aforementioned procedure, the aforementioned surface being provided with a transferable protective layer. Then the surface was dried to form the ink layer shown in FIG. 2(a), whereby producing the thermal transfer ink sheet 1 wherein ink layer and transferable protective layer were arranged according to the frame sequential method.

| | |
|---|---|
| <Yellow ink coating solution 1> | |
| Yellow dye Y-1: | 4.0 parts by mass |
| Yellow dye Y-2: | 2.0 parts by mass |
| Polyvinyl acetoacetal resin (KS-5 by Sekisui | 3.0 parts by mass |
| Chemical Co., Ltd.): | |
| Toluene: | 45.0 parts by mass |
| Methyl ethyl ketone: | 45.0 parts by mass |
| (Magenta ink coating solution 1) | |
| Magenta dye M-1: | 4.0 parts by mass |
| Magenta dye M-2: | 1.4 parts by mass |
| Polyvinyl acetoacetal resin (KS-5 by Sekisui | 3.0 parts by mass |
| Chemical Co., Ltd.): | |
| Toluene: | 45.0 parts by mass |
| Methyl ethyl ketone: | 45.0 parts by mass |
| (Cyan ink coating solution 1) | |
| Cyan dye C-1: | 4.0 parts by mass |
| Cyan dye C-2: | 1.0 parts by mass |
| Polyvinyl acetoacetal resin (KS-5 by Sekisui | 3.0 parts by mass |
| Chemical Co., Ltd.): | |
| Toluene: | 45.0 parts by mass |
| Methyl ethyl ketone: | 45.0 parts by mass |

Y-1

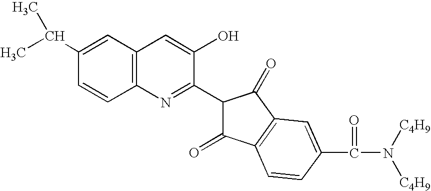

Y-2

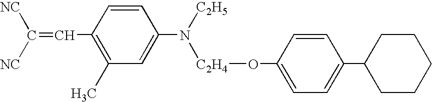

M-1

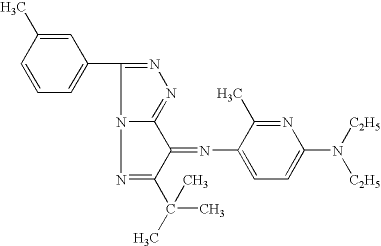

M-2

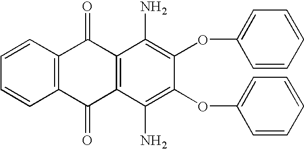

C-1

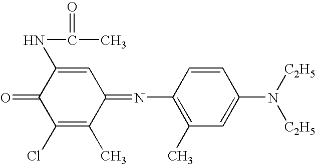

C-2

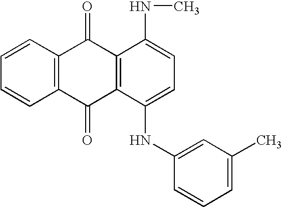

<<Manufacturing the Thermal Transfer-Image Receiving Sheet>>
[Manufacturing the Thermal Transfer Image Receiving Sheet 1-1]

The following intermediate layer coating solution was applied according to the gravure coating method on one side of synthetic paper (Yupo FPG-150 by Oji Petrochemical Synthetic Paper Co., Ltd.) as a substrate sheet having a thickness of 150 μm, so that the solution would be 2.0 g/m² in terms of dry weight as a solid. Then the paper was dried to form an intermediate layer. Then the pigment receiving layer coating solution composed of the following compositions was applied on the aforementioned intermediate layer according to the gravure coating method, so that the amount would be 45 grams per square meter. It was dried to get a thermal transfer image receiving sheet 1-1.

(Intermediate layer coating solution)

| | |
|---|---|
| Urethane resin (Nipporan 5199 by Nippon | 5.0 parts by mass |
| Polyurethane Co., Ltd.): | |
| Isocyanate (Takenate A-14 Takeda | 2.0 parts by mass |
| Chemical Industries, Ltd.): | |
| Methyl ethyl ketone: | 20.0 parts by mass |
| Toluene: | 20.0 parts by mass |

(Pigment receiving layer coating solution)

| | |
|---|---|
| Vinyl chloride/vinyl acetate copolymer resin | 7.0 parts by mass |
| (#1000 ALK by Denki Kagaku Kogyo Co., Ltd.): | |
| Methylstyryl modified silicone oil (KF410 | 0.6 parts by mass |
| by Shinetsu Chemical Co. Ltd.): | |
| Methyl ethyl ketone: | 40.0 parts by mass |
| Toluene: | 40.0 parts by mass |
| Butyl acetate: | 10.0 parts by mass |

[Manufacturing the Thermal Transfer Image Receiving Sheets 1-2 through 1-19]

When the aforementioned thermal transfer image receiving sheet 1-1 was manufactured, the pigment receiving layer coating solution of the following composition provided with dispersion treatment was applied according to the gravure coating method on the intermediate layer so that the amount would be 45 grams per square meter. Then it was dried to get a thermal transfer image receiving sheets 1-2 through 1-19. The drying conditions were adjusted according to the void ratio given in Table 1.

(Pigment receiving layer)

| | |
|---|---|
| Vinyl chloride/vinyl acetate copolymer resin | 7.0 parts by mass |
| (#1000 ALK by Denki Kagaku Kogyo Co., Ltd.): | |
| Methylstyryl modified silicone oil (KF410 | 0.6 parts by mass |
| by Shinetsu Chemical Co. Ltd.): | |
| Inorganic particles: | Amount meeting |
| | the void ratio |
| | listed in Table 1 |
| Methyl ethyl ketone: | 40.0 parts by mass |
| Toluene: | 40.0 parts by mass |
| Butyl acetate: | 10.0 parts by mass |

The following describes the details of the inorganic particles given in Table 1:

| | |
|---|---|
| Alumina/silica mixture oxide: by Nippon Aerosil Co., | 30 nm |
| Ltd.; average particle size: | |
| Hydrophobic silica anhydride: by Wackers Chemicals | 14 nm |
| East Asia Co., Ltd.; average particle size: | |
| Alumina doped silica: by Degussa Co., Ltd.; average | 80 nm |
| primary particle size: | |
| Hydrophobic titanium oxide: | |
| Obtained by treatment of hydrophilic titanium oxide (by | |
| Nippon Aerosil Co., Ltd.; average particle size: 20 nm) using | |
| hexamethyldisilazane. | |

<<Image Formation>>

As shown in FIG. 3, at a temperature of about 40 degrees Celsius with a relative humidity of 80 percent, the receiving layer of each thermal transfer ink sheet manufactured in the aforementioned procedure and the ink layer of the thermal transfer ink sheet 1 were placed one on top of the other, and were set to the thermal transfer recording apparatus provided with a thermal head having a 300 dpi-line head (“dpi” refers to the number of dots per 2.54 cm) wherein the resistor is square (80 μm in the main scanning direction by 120 μm in the sub-scanning direction). They are pressed by the thermal head and platen roll, wherein the pressure was gradually increased within the range of applied energy from 0 through 260 μJ per dot. Each pigment and protective layer were transferred onto the receiving layer of the thermal transfer image receiving sheet by heating from the back of the ink layer, so that a neutral step pattern image (where “neutral” refers to the color gained by superimposition of three colors—yellow, magenta and cyan) would have a feed length of 85 μm per line and a printing speed (feed rate) of 1.5 msec. per line, whereby an image was formed and the printed material was created.

<<Evaluating the Formed Image>>

The printed material having been produced according to the aforementioned procedure was evaluated according to the following criteria:

(Evaluating the Maximum Density)

The maximum density (a visible gradation value of 255) of the neutral step pattern patch image produced according to the aforementioned procedure was measured using a reflection densitometer (X-rite 310 by Gretag Machbeth Inc.). The maximum density was evaluated according to the following criteria:

B; Maximum density: 2.0 or more C; Maximum density: 1.8 through 2.0 excl.

D; Maximum density: 1.6 through 1.8 excl.

(Evaluating the Resistance to Rog)

Cyan densities of the non-image portion (where only the protective layer other than image pattern was transferred) and thermal transfer image receiving sheet prior to printing were measured using a reflection densitometer (X-rite 310 by Gretag Machbeth Inc.). The resistance to fog was evaluated according to the following criteria:

B: The difference between cyan density in the non-image area after printing and that on the image receiving sheet before printing is less than 0.01.

C: The difference between cyan density in the non-image area after printing and that on the image receiving sheet before printing is 0.01 through 0.03 excl.

D: The difference between cyan density in the non-image area after printing and that on the image receiving sheet before printing is 0.03 or more.

Table 1 shows the result of evaluation obtained from the aforementioned procedure.

TABLE 1

| | Thermal transfer image | | | Evaluation | | |
|---|---|---|---|---|---|---|
| | receiving sheet | | | result | | |
| Image | | | Void ratio | Max. | Fog | |
| No. | No. | Inorganic particle | (%) | density | resistance | Remarks |
| 1-1 | 1-1 | Alumina/silica | — | B | D | Comparative |
| | | mixture oxide | | | | example |
| 1-2 | 1-2 | Alumina/silica | 5 | B | D | Comparative |
| | | mixture oxide | | | | example |
| 1-3 | 1-3 | Alumina/silica | 10 | B | B | Present |
| | | mixture oxide | | | | invention |
| 1-4 | 1-4 | Alumina/silica | 30 | B | B | Present |
| | | mixture oxide | | | | invention |
| 1-5 | 1-5 | Alumina/silica | 50 | B | B | Present |
| | | mixture oxide | | | | invention |
| 1-6 | 1-6 | Alumina/silica | 60 | B | B | Present |
| | | mixture oxide | | | | invention |
| 1-7 | 1-7 | Alumina/silica | 65 | C | B | Comparative |
| | | mixture oxide | | | | example |
| 1-8 | 1-8 | Alumina/silica | 70 | D | B | Comparative |
| | | mixture oxide | | | | example |
| 1-9 | 1-9 | Hydrophobic silica | 5 | B | D | Comparative |
| | | anhydride | | | | example |
| 1-10 | 1-10 | Hydrophobic silica | 10 | B | B | Present |
| | | anhydride | | | | invention |
| 1-11 | 1-11 | Hydrophobic silica | 30 | B | B | Present |
| | | anhydride | | | | invention |
| 1-12 | 1-12 | Hydrophobic silica | 50 | B | B | Present |
| | | anhydride | | | | invention |
| 1-13 | 1-13 | Hydrophobic silica | 60 | B | B | Present |
| | | anhydride | | | | invention |
| 1-14 | 1-14 | Hydrophobic silica | 65 | C | B | Comparative |
| | | anhydride | | | | example |
| 1-15 | 1-15 | Hydrophobic silica | 70 | D | B | Comparative |
| | | anhydride | | | | example |
| 1-16 | 1-16 | Alumina doped silica | 30 | B | B | Present |
| | | | | | | invention |
| 1-17 | 1-17 | Alumina doped silica | 50 | B | B | Present |
| | | | | | | invention |
| 1-18 | 1-18 | Hydrophobic titanium | 30 | B | B | Present |
| | | oxide | | | | invention |
| 1-19 | 1-19 | Hydrophobic titanium | 50 | B | B | Present |
| | | oxide | | | | invention |

As will be apparent from the result described in Table 1, a void layer of the present invention is provided in contrast with the thermal transfer image receiving sheet 1-1 having no void structure. Further, the void ratio of this void layer is 10 through 60% in the thermal transfer image receiving sheet of the present invention. Table 1 shows that the thermal transfer image receiving sheet of the present invention provides a high printing density and satisfactory performances without a fog.

### Embodiment 2

<<Manufacturing the Thermal Transfer Image Receiving Sheets 2-1 through 2-18>>

The thermal transfer image-receiving sheets 2-1 through 2-18 were manufactured in the -same procedure as that of the aforementioned thermal transfer image receiving sheets 1-1, 1-4 and 1-16 described in the first embodiment, except that 2.0 parts by mass of the compounds in Group A of Table 2 were added to the pigment receiving layer coating solution.

The following describes the details of the compounds in Group A of Table 2 given in abbreviations:

DMP: Dimetyl phthalate

TOP: Tri (2-ethylhexyl)phosphate

TOPO: Tri-n-octyl phosphine oxide

MDS: Dimethyl sebacate

TOTM: Tris (2-ethylhexyl) trimellitate

When two compounds are used in combination (2-16 through 2-18), the mass ratio is 1 to 1 for all cases.

<<Image Formation and Evaluation>>

The thermal transfer image receiving sheets 1-1 and thermal transfer image receiving sheets 2-1 through 2-18 image 2-1 through 2-19 were created and evaluated under the same conditions as those in the first embodiment, except that the room temperature was used as the printing temperature, and the printing speed was 0.7 msec. per line.

In addition to the evaluation described in the first embodiment, the blocking resistance of each thermal transfer image receiving sheet prior to formation of an image was evaluated according to the following procedure.

(Evaluating the Blocking Resistance)

The thermal transfer image receiving sheets manufactured according to the aforementioned procedure were laminated in the form of a small roll, and were left to stand for two days at 60 degrees Celsius. Then they were unrolled, and blocking having occurred on the thermal transfer receiving surface was checked by visual observation. Then The blocking resistance was evaluated according to the following criteria:

B; No transfer of the constituent layer onto the contact surface was observed. Smooth unrolling was carried out.

C; Although no transfer of the constituent layer onto the contact surface was observed, separation noise was perceived at the time of unrolling.

D; Transfer of the constituent layer onto the contact surface was observed. Smooth unrolling was discouraged by adhesion.

Table 2 shows the result of the aforementioned evaluation:

TABLE 2

| | Thermal transfer image receiving | | | | Evaluation | | | |
|---|---|---|---|---|---|---|---|---|
| | sheet | | | | result | | | |
| Image | | Inorganic | Void ratio | Compound of | Max. | Fog | Blocking | |
| No. | No. | particle | (%) | Group A | density | resistance | resistance | Remarks |
| 2-1 | 1-1 | — | — | — | D | D | B | Comparative |
| | | | | | | | | example |
| 2-2 | 2-1 | — | — | DMP | B | D | D | Comparative |
| | | | | | | | | example |
| 2-3 | 2-2 | — | — | TOP | B | D | D | Comparative |
| | | | | | | | | example |
| 2-4 | 2-3 | — | — | TOPO | B | D | D | Comparative |
| | | | | | | | | example |
| 2-5 | 2-4 | — | — | DMS | B | D | D | Comparative |
| | | | | | | | | example |
| 2-6 | 2-5 | — | — | TOTM | B | D | D | Comparative |
| | | | | | | | | example |
| 2-7 | 2-6 | Alumina/silica | 30 | DMP | B | B | B | Present |
| | | mixture oxide | | | | | | invention |
| 2-8 | 2-7 | Alumina/silica | 30 | TOP | B | B | B | Present |
| | | mixture oxide | | | | | | invention |
| 2-9 | 2-8 | Alumina/silica | 30 | TOPO | B | B | B | Present |
| | | mixture oxide | | | | | | invention |
| 2-10 | 2-9 | Alumina/silica | 30 | DMS | B | B | B | Present |
| | | mixture oxide | | | | | | invention |
| 2-11 | 2-10 | Alumina/silica | 30 | TOTM | B | B | B | Present |
| | | mixture oxide | | | | | | invention |
| 2-12 | 2-11 | Alumina doped | 30 | DMP | B | B | B | Present |
| | | silica | | | | | | invention |
| 2-13 | 2-12 | Alumina doped | 30 | TOP | B | B | B | Present |
| | | silica | | | | | | invention |
| 2-14 | 2-13 | Alumina doped | 30 | TOPO | B | B | B | Present |
| | | silica | | | | | | invention |
| 2-15 | 2-14 | Alumina doped | 30 | DMS | B | B | B | Present |
| | | silica | | | | | | invention |
| 2-16 | 2-15 | Alumina doped | 30 | TOTM | B | B | B | Present |
| | | silica | | | | | | invention |
| 2-17 | 2-16 | Alumina doped | 30 | TOP/DMS | B | B | B | Present |
| | | silica | | | | | | invention |
| 2-18 | 2-17 | Alumina doped | 30 | TOP/TOTM | B | B | B | Present |
| | | silica | | | | | | invention |
| 2-19 | 2-18 | Alumina doped | 30 | TOP/TOPO | B | B | B | Present |
| | | silica | | | | | | invention |

As will be apparent from the result described in Table 2, printing was carried out at a high speed in the comparative example having no void structure. A high printing speed density was maintained when the compounds of Group 1 were added. However, fog and blocking were observed. By contrast, when the compound of Group A was added to the thermal transfer image receiving sheet having a void ratio defined in the present invention, a high printing speed density was maintained, and at the same time, excellent performances were obtained without fog or blocking.

### Embodiment 3

<<Manufacturing the Thermal Transfer Image Receiving Sheet 2>>

The thermal transfer ink sheet 2 was manufactured according to the same procedure as that used in manufacturing the thermal transfer ink sheet 1 described in the first embodiment, except that the yellow ink coating solution 1, magenta ink coating solution 1 and cyan ink coating solution 1 used for preparing the ink layers were changed to the yellow ink coating solution 2, magenta ink coating solution 2 and cyan ink coating solution 2 described below.

| | |
|---|---|
| <Yellow ink coating solution 2> | |
| Post-chelate pigment Y-3: | 4.5 parts by mass |
| Polyvinyl acetoacetal resin (Esrex KS-5 by Sekisui | 5.0 parts by mass |
| Chemical Co., Ltd.): | |
| Urethane modified silicone resin (Diaromer SP-2105 | 0.5 parts by mass |
| by Dainichi Seikasha Co., Ltd.): | |
| Methyl ethyl ketone: | 45.0 parts by mass |
| Toluene: | 45.0 parts by mass |
| <Magenta ink coating solution 2> | |
| Post-chelate pigment M-3: | 4.0 parts by mass |
| Polyvinyl acetoacetal resin (Esrex KS-5 by Sekisui | 5.5 parts by mass |
| Chemical Co., Ltd.): | |
| Urethane modified silicone resin (Diaromer SP-2105 | 0.5 parts by mass |
| by Dainichi Seikasha Co., Ltd.): | |
| Methyl ethyl ketone: | 45.0 parts by mass |
| Toluene: | 45.0 parts by mass |
| <Cyan ink coating solution 2> | |
| Post-chelate pigment C-3: | 4.0 parts by mass |
| Polyvinyl acetoacetal resin (Esrex KS-5 by Sekisui | 5.5 parts by mass |
| Chemical Co., Ltd.): | |
| Urethane modified silicone oil (Diaromer SP-2105 | 0.5 parts by mass |
| by Dainichi Seikasha Co., Ltd.): | |
| Methyl ethyl ketone: | 45.0 parts by mass |
| Toluene: | 45.0 parts by mass |

| | |
|---|---|
| Y-3 | 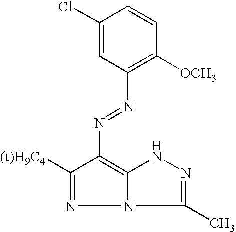 |
| M-3 | 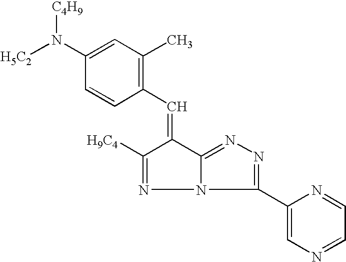 |
| C-3 | 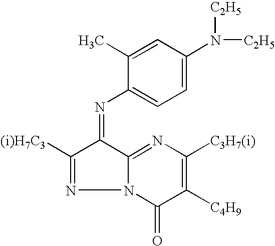 |

<<Manufacturing the Thermal Transfer Image Receiving Sheet>>
[Manufacturing the Thermal Transfer Image receiving Sheets 3-1 and 3-2]

The following intermediate layer coating solution was applied according to the gravure coating method on one side of synthetic paper (Yupo FPG-150 by Oji Petrochemical Synthetic Paper Co., Ltd.) as a substrate sheet having a thickness of 150 μm, so that the solution would be 2.0 g/m² in terms of dry weight as a solid. Then the paper was dried to form an intermediate layer. Then the pigment receiving layer coating solution composed of the following compositions was applied on the aforementioned intermediate layer according to the gravure coating method, so that the amount would be 35 grams per square meter. It was dried to get a thermal transfer image receiving sheets 3-1 and 3-2.

(Intermediate layer coating solution)

| | |
|---|---|
| Urethane resin (Nipporan 5199 by Nippon | 5.5 parts by mass |
| Polyurethane Co., Ltd.): | |
| Isocyanate (Takenate A-14 Takeda Chemical | 2.0 parts by mass |
| Industries, Ltd.): | |
| Methyl ethyl ketone: | 20.0 parts by mass |
| Toluene: | 20.0 parts by mass |

(Pigment receiving layer coating solution)

| | |
|---|---|
| Polyvinyl butyral resin (Esrex BX-l by Sekisui Chemical Co., Ltd.): | 7.0 parts by mass |
| Metal source (compounds listed in Table 3): | 2.5 parts by mass |
| Methylstyryl modified silicone oil (KF410 by Shinetsu Chemical Co., Ltd.): | 0.6 parts by mass |
| Methyl ethyl ketone: | 40.0 parts by mass |
| Toluene: | 40.0 parts by mass |
| Butyl acetate: | 10.0 parts by mass |

MS-1:
Ni²⁺[C₇H₁₅COC(COOCH₃)═C(CH₃O⁻]₂
MS-2

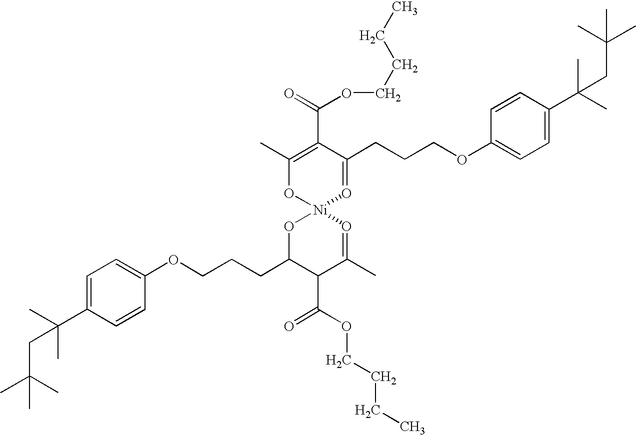

[Manufacturing the Thermal Transfer Image Receiving Sheets 3-3 through 3-6]

When the aforementioned thermal transfer image receiving sheet 3-1 was manufactured, the pigment receiving layer coating solution of the following composition provided with dispersion treatment was applied according to the gravure coating method on the intermediate layer so that the amount would be 35 grams per square meter. Then it was dried to get a thermal transfer image receiving sheets 3-3 through 3-6. The drying conditions were adjusted according to the void ratio given in Table 3.

(Pigment receiving layer)

| | |
|---|---|
| Vinyl chloride/vinyl acetate copolymer resin | 7.0 parts by mass |
| (#1000 ALK by Denki Kagaku Kogyo Co., Ltd.): | |
| Metal source (compounds listed in Table 3) | 2.5 parts by mass |
| Methylstyryl modified silicone oil (KF410 | 0.6 parts by mass |
| by Shinetsu Chemical Co. Ltd.): | |
| Inorganic particles: | Amount according |
| | to the void ration |
| | given in Table 3 |
| Methyl ethyl ketone: | 40.0 parts by mass |
| Toluene: | 40.0 parts by mass |
| Butyl acetate: | 10.0 parts by mass |

<<Image Formation>>

Printing and evaluation were conducted under the same conditions as those of the first embodiment, using a combination of thermal transfer image receiving sheets 3-1 through 3-6 and thermal transfer ink sheet 2 manufactured according to the aforementioned procedure, and a combination between the image receiving sheets 1-1, 1-4 and 1-16 and thermal transfer ink sheet 1 manufactured in the first embodiment.

In addition to the evaluation described in the first embodiment the light resistance of the printed material was evaluated according to the following criteria:

(Evaluation of Light Resistance)

The density (D1) in the step where the reflection density of cyan of the neutral step pattern patch image manufactured according to the aforementioned procedure is close to 1.0 was measured. Then it was exposed to a xenon fade meter (70,000 luces) for seven days. After that, cyan reflection density (D2) in the same step was measured and the survival rate of the pigment was obtained according to the following formula, whereby light resistance was evaluated.

Survival rate of cyan pigment in the neutral (%) =[reflection density (D2) after exposure/unexposed reflection density (D1)]×100

Table 3 shows the result of evaluation obtained from the aforementioned procedure.

TABLE 3

| | Thermal transfer image receiving | | | | Evaluation | | | |
|---|---|---|---|---|---|---|---|---|
| | sheet | | | | result | | | |
| | | | Void | | | | Light | |
| Image | | Inorganic | ratio | Metal | Max. | Fog | resistance | |
| No. | No. | particle | (%) | source | density | resistance | (%) | Remarks |
| 3-1 | 1-1 | — | — | — | B | D | 65 | Comparative |
| | | | | | | | | example |
| 3-2 | 1-4 | Alumina/silica | 30 | — | B | B | 81 | Present |
| | | mixture oxide | | | | | | invention |
| 3-3 | 1-16 | Alumina doped | 30 | — | B | B | 81 | Present |
| | | silica | | | | | | invention |
| 3-4 | 3-1 | — | — | MS-1 | B | D | 65 | Comparative |
| | | | | | | | | example |
| 3-5 | 3-2 | — | — | MS-2 | B | D | 66 | Comparative |
| | | | | | | | | example |
| 3-6 | 3-3 | Alumina/silica | 30 | MS-1 | B | B | 90 | Present |
| | | mixture oxide | | | | | | invention |
| 3-7 | 3-4 | Alumina doped | 30 | MS-1 | B | B | 91 | Present |
| | | silica | | | | | | invention |
| 3-8 | 3-5 | Alumina/silica | 30 | MS-2 | B | B | 91 | Present |
| | | mixture oxide | | | | | | invention |
| 3-9 | 3-6 | Alumina doped | 30 | MS-2 | B | B | 91 | Present |
| | | silica | | | | | | invention |

The result described in Table 3 clearly indicates that, when the metal source is added to thermal transfer image receiving sheet having a void ratio defined in the present invention, a high printing speed density is maintained, and fog does not occur. Not only that, this arrangement provides a substantial improvement in light resistance and an updated configuration, as compared to that of the thermal transfer image receiving sheets (1-4 and 1-16) of the present invention that does not contain a metal source.

What is claimed is:

1. A thermal transfer image receiving sheet comprising:
a substrate sheet; and
a pigment receiving layer which is capable of receiving a thermal diffusible pigment and includes inorganic particles and hydrophobic resin,
wherein a void ratio of said pigment receiving layer is 10 through 60%.

2. The thermal transfer image receiving sheet of claim 1, wherein said pigment receiving layer comprises at least one of an organic phosphine compound, phosphoric acid ester, phthalic acid ester compound, aliphatic dibasic acid ester compound and trimellitic acid ester compound.

3. The thermal transfer image receiving sheet of claim 1, wherein said pigment receiving layer comprises a metal ion-containing compound.

4. An image forming method comprising the steps of:
superimposing said thermal transfer image receiving sheet of claim 1 on a thermal transfer ink sheet containing thermal diffusible pigments;
heating said thermal transfer image receiving sheet and thermal transfer ink sheet superimposed thereon according to recording signals; and
transferring the thermal diffusible pigment contained in the thermal transfer ink sheet onto the thermal transfer image receiving sheet.
